(19) United States
(12) Patent Application Publication
(10) Pub. No.: US 2016/0071167 A1
(43) Pub. Date: Mar. 10, 2016

(54) SYSTEM AND METHOD FOR SELLING AND PURCHASING ADVERTISING SPACE ON OUT OF HOME ELECTRONIC DIGITAL MEDIA DEVICES

(71) Applicant: New Co, LLC d/b/a MediaBiz 365, Albuquerque, NM (US)

(72) Inventors: Curtis Jingle, Albuquerque, NM (US); James Guthrie, Albuquerque, NM (US); Marvin Rodgers, Albuquerque, NM (US)

(21) Appl. No.: 14/478,006

(22) Filed: Sep. 5, 2014

(51) Int. Cl. G06Q 30/02

(52) U.S. Cl. CPC G06Q 30/0275

(57) ABSTRACT

The present disclosure relates to the ability to perform online auction and purchase of advertising space on out of home electronic, digital media devices over the Internet. The buyer end user will look for, bid through auction or buy now, and purchase won advertising space through the Internet via the present disclosure. Professional media buyers, such as marketing agencies and/or brands will create a buy plan, query for matching advertising space based upon plan criteria, and make a bulk buy of that matching space through the Internet via the present invention. The owner/operator of indoor or outdoor electronic, digital media device will offer up through the present disclosure their available advertising space.

### FIELD

The present disclosure relates to the sale and purchase of advertising space on electronic digital media devices, and more particularly, to systems and methods for online auctions of advertising space on out of home electronic, digital media devices.

### BACKGROUND

The ability to advertise on out of home electronic, digital media (e.g., digital billboards, digital signs, monitors, etc.) is becoming increasingly popular throughout the world. Such advertising provides the ability to efficiently reach relatively large audiences with specifically targeted advertising. Known methods of connecting advertisers with sellers offering advertising space, whether on electronic digital media or printed media, are often inefficient, time consuming, and geographically limited. As a result, advertising space sometimes is not sold or used, advertising space may be sold for less than the maximum price that might be commanded by the advertising space, advertisers may purchase advertising space in a less than desirable geographic or temporal location, and advertisers may have difficulty finding desirable advertising space.

### SUMMARY

One aspect of the present disclosure is a computing device for facilitating sales of digital media device advertising space. The computing device includes a processor and a memory coupled to the processor. The memory includes computer-executable instructions that, when executed by the processor, cause the computing device to: generate, based on advertising space data provided by a digital media device owner, an electronic listing of an advertising space available for purchase; receive, from at least one prospective buyer, at least one bid for purchase of the advertising space; end the electronic listing of the advertising space at a predetermined time after the electronic listing was generated; and determine a winning bidder for the listing of the advertising space, wherein the winning bidder is the prospective buyer who submitted the highest bid for purchase of the advertising space.

Another aspect of the present disclosure is a computing device for facilitating sales of digital media device advertising space. The computing device includes a processor and a memory coupled to the processor. The memory includes computer-executable instructions that, when executed by the processor, cause the computing device to: generate, based on advertising space data provided by a digital media device owner, an electronic listing of an advertising space available for purchase, the electronic listing including a buy now price; and end the electronic listing of the advertising space upon receipt of an acceptance of the buy now price from a buyer.

Another aspect of the present disclosure is a method for facilitating sales of digital media device advertising space. The method includes: a computing device generating a plurality of electronic listings of advertising space available for purchase based on advertising space data provided by digital media device owners; a server receiving bids for purchase of one or more of the electronic listings of advertising space available for purchase from a plurality of prospective buyers; ending the respective electronic listings of the advertising space at a predetermined time after the respective electronic listing was generated; and the server determining a winning bidder for the respective electronic listing of the advertising space, wherein the winning bidder is the prospective buyer who submitted the highest bid for purchase of the respective advertising space.

### BRIEF DESCRIPTION OF THE DRAWINGS

The present invention is illustrated by way of example and not limitation in the figures of the accompanying drawings, in which like references indicate similar elements and in which:

FIG. 1 is a block diagram of an exemplary system in accordance with one embodiment of the present disclosure.

FIG. 2 is an expanded block diagram of an exemplary embodiment of a server architecture of the system shown in FIG. 1.

FIG. 3 illustrates an exemplary configuration of a computer device such as the client devices shown in FIGS. 1 and 2.

FIG. 4 illustrates an exemplary configuration of a server computer device such as the server system shown in FIGS. 1 and 2.

FIG. 5 illustrates the parties involved in an exemplary advertising auction and/or purchase.

FIGS. 6 and 7 illustrate an example of a process for purchasing available listings on the system shown in FIG. 1.

FIGS. 8-12 are a flow diagrams of an exemplary online auction process using the system shown in FIG. 1.

FIG. 13 illustrates an exemplary message communication process between a buyer end user and an administrator/broker.

FIG. 14 illustrates an exemplary message communication process between the owner/operator and an administrator/broker.

FIG. 15 illustrates an exemplary message communication process between the professional buyer and an administrator/broker.

FIG. 16 is an exemplary functional diagram of an owner/operator management system portion of an advertising auction system.

FIGS. 17-23 are flow diagrams of an owner/operator's use of the management system shown in FIG. 1 and FIG. 16.

FIG. 24 is an exemplary functional diagram of a professional buyer end user buy planner system portion of an advertising auction system.

FIGS. 25-31 are flow diagrams of a professional buyer end user's use of the buy planner system shown in FIG. 1 and FIG. 24.

FIG. 32 is a screen capture of a home page of an example embodiment of a web application according to the present disclosure.

### DETAILED DESCRIPTION

In the following description, the present disclosure details are fully described and provide a thorough understanding of the present disclosure. Refer to the drawings throughout this description and specific details will reference the numeral indicators within the drawings.

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure.

As used herein, an element or step recited in the singular and preceded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Embodiments of the present disclosure described herein relate to the sale and purchase of advertising space on electronic, digital media devices, and more particularly, to systems and methods for online auctions of advertising space on electronic, digital media devices, such as out of home electronic, digital media devices.

Methods and systems of the present disclosure allow users to search online and purchase advertising space on electronic, digital media devices. Users of the system can include buyer end users or professional users having access to the Internet via their computing device's web browser. The system enables users to look for, bid through auction, and purchase (for example, for the buyer end user, won at auction or purchased using a buy now option; for the professional user, purchased through the buy planner) advertising space on out of home electronic, digital media devices throughout the world. A buyer is able to target any audience where a media device is available and the owner/operator of the device is listing their available advertising space.

An owner/operator of a digital media device uses a management system that allows for the administration of their digital media device inventory, time slot management, and listings.

A buyer end user may benefit through targeted advertising to a particular audience through out of home electronic, digital media once purchased. A buyer desiring to advertise on this media, while on the Internet, is be able to look for and purchase available advertising space anywhere throughout the world.

A professional user (e.g., marketing agency and/or brand) may benefit through targeted advertising to a particular audience through out of home electronic, digital media once purchased. A professional buyer desiring to advertise on this media, while on the Internet, is be able to create a buy plan establishing regions, categories, postal codes with a radius, demographics and a budget can evaluate the multiple active listings meeting their criteria. Once a user is satisfied with the query results, they can immediately purchase the listings meeting their criteria.

For all buyer types, the system allows for a greater reach to a potentially large audience on multiple digital media devices.

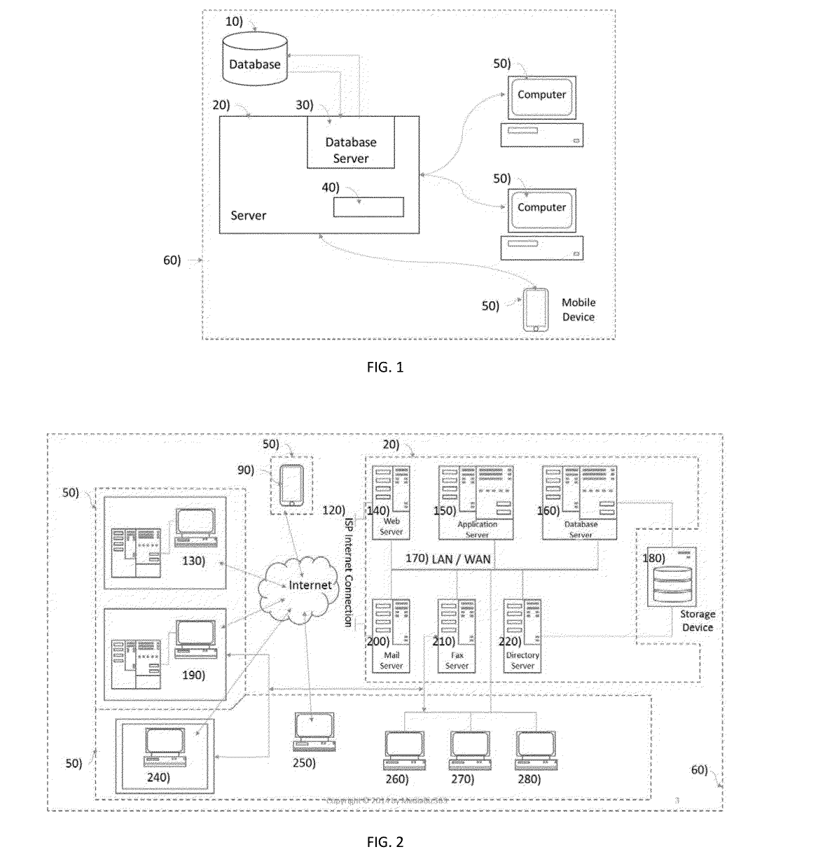

FIG. 1 is a simplified block diagram of an exemplary auction and management system 60 in accordance with one embodiment of the present disclosure. This system 60 is an auction and management system that can be utilized for online auctions of advertising space on electronic, digital media as described in more detail below.

In the example of FIG. 1, the system 60 includes a server system 20, which is a type of computer system, and a plurality of client sub-systems (also referred to as client systems 50 operatively connected to server system 20. In one embodiment, client systems 50 are computers including a web browser and/or a chat client, such that server system 20 is accessible to client systems 50 over the Internet or other network. Client systems 50 are interconnected to the Internet through many interfaces including a network, such as a local area network (LAN) or a wide area network (WAN), dial-in-connections, cable modems, and special high-speed ISDN lines, etc. Client systems 50 may be comprised of any device capable of interconnecting to the Internet including a web-based phone, personal digital assistant (PDA), or other web-based connectable equipment.

A database server 30 is operatively connected to database 10, which contains information on a variety of matters, as described below in greater detail. In one example, centralized database 10 is stored on server system 20 and can be accessed by logging onto server system 20 through one of client systems 50. In another example, database 10 is stored remotely from server system 20 and may be non-centralized. Database 10 may store auction data, advertising space data, advertiser account and/or profile data, seller account and/or profile data, templates, etc.

FIG. 2 is an expanded block diagram of an exemplary embodiment of a server architecture of an auction and management system 60 in accordance with one embodiment of the present disclosure. Components in system 60 that correspond to components shown in FIG. 1 are identified in FIG. 2 using the same reference numerals as used in FIG. 1. System 60 includes server system 20 and client systems 50. Server system 20 further includes database server 160, an application transaction server 150, a web server 140, a fax server 210, a directory server 220, and a mail server 200. A storage device 180 is coupled to database server 160 and directory server 220. Servers 140, 150, 160, 200, 210, and 220 are coupled in a local area network (LAN) 170. In some embodiments, server system 20 and/or one or more of servers 140, 150, 160, 200, 210, and 220 may be distributed across a number of network entities (e.g., a “cloud computing” arrangement). Workstations 260, 270, and 280 are coupled to LAN 170. Alternatively, workstations 260, 270, and 280 are coupled to LAN 170 using an Internet link or are connected through an Intranet. Workstations 240 and 250 are coupled to LAN 170 using an Internet link. Similarly, workstations 190 and 130 and mobile device 90 can access system 60 using via the Internet.

In the example shown in FIG. 2, the workstations 240, 250, 260, 270, and 280 are personal computers having a web browser. Although the functions performed at the workstations typically are illustrated as being performed at respective workstations 240, 250, 260, 270, and 280, such functions can be performed at one of many personal computers coupled to LAN 170.

Server system 60 is configured to be communicatively coupled to various individuals using an ISP Internet connection 120. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 170, local area network (LAN) 170 could be used in place of WAN 170.

In one example, any authorized individual having a mobile device 90 can access system 60. In on example, the mobile device 90 may be a mobile phone. Alternatively, the mobile device 90 can be a PDA, tablet computer, wearable computer, or other mobile device. Also, the mobile device 90 is configured to communicate with server system 20.

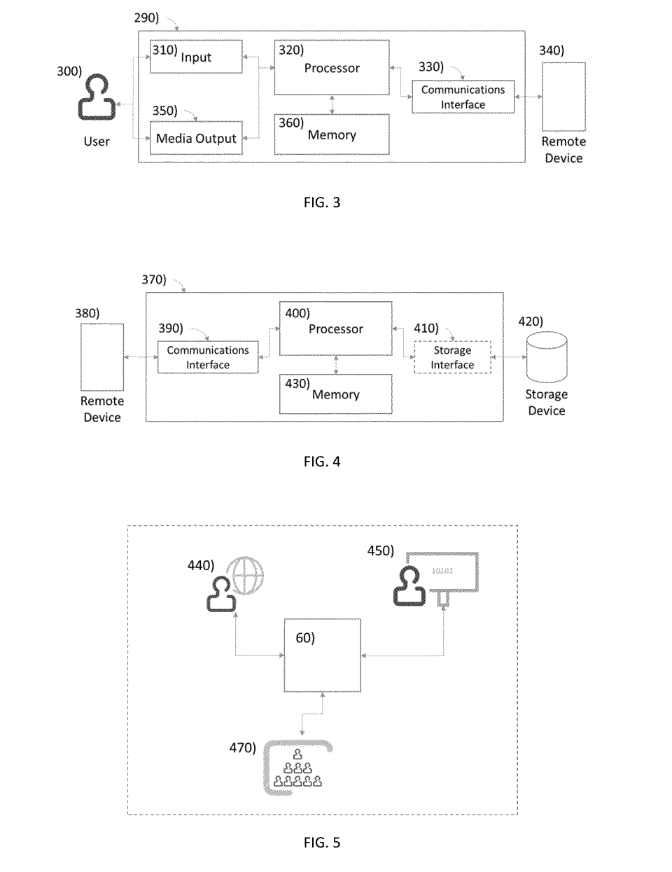

FIG. 3 illustrates an exemplary configuration of a computer device 290 operated by user 300 such as client systems 50 shown in FIGS. 1 and 2. The user's computer device 290 may include, but is not limited to, client systems 50, workstations 240, 250, 260, 270, and 280, and mobile device 90.

In some examples, the computer device 290 includes a processor 320 for executing instructions. In some examples, executable instructions are stored in a memory area 360. Processor 320 may include one or more processing units (e.g., in a multi-core configuration). Memory area 360 may be comprised of any device allowing information such as executable instructions and/or other data to be stored and retrieved. Memory area 360 may include one or more computer readable media.

In some examples, the computer device 290 also includes at least one media output component 350 for presenting information to user 300. The media output component 350 may be any component capable of conveying information to user 300. In some examples, the media output component 350 includes an output adapter such as a video adapter and/or an audio adapter. An output adapter is operatively coupled to processor 320 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some examples, the computer device 290 includes an input device 310 for receiving input from user 300. Input device 310 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 350 and input device 310.

In some examples, the computer device 290 may also include a communication interface 330, which is communicatively couplable to a remote device 340 such as server system 10. Communication interface 330 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 360 are, for example, computer readable instructions for providing a user interface to user 300 via media output component 350 and, optionally, receiving and processing input from input device 310. A user interface may include, among other possibilities, a web browser and client application. Web browsers enable users, such as user 300, to display and interact with media and other information typically embedded on a web page or a website from server system 10. A client application allows user 300 to interact with a server application from server system 10.

FIG. 4 illustrates an exemplary configuration of a server computer device 370 such as server system 10 shown in FIGS. 1 and 2. Server computer device 370 may include, but is not limited to, database server 160, application transaction server 150, web server 140, fax server 210, directory server 220, and mail server 200 (FIG. 2).

In some examples, the server computer device 370 includes a processor 400 for executing instructions. Instructions may be stored in a memory area 430, for example. Processor 400 may include one or more processing units (e.g., in a multi-core configuration). Processor 400 is operatively coupled to a communication interface 390 such that server computer device 370 is capable of communicating with a remote device 380 such as computer device 290 (FIG. 2) or another server computer device 370. For example, communication interface 390 may receive requests from client systems 50 via the Internet, as illustrated in FIGS. 1 and 2.

Processor 400 may also be operatively coupled to a storage device 420. Storage device 420 may be comprised of any computer-operated hardware suitable for storing and/or retrieving data. In some examples, storage device 420 is integrated in server computer device 370. For example, server computer device 370 may include one or more hard disk drives as storage device 420. In other embodiments, storage device 420 is external to server computer device 370 and may be accessed by a plurality of server computer devices 370. For example, storage device 420 may include multiple storage units such as hard disks or solid state disks in a redundant array of inexpensive disks (RAID) configuration. Storage device 420 may include a storage area network (SAN) and/or a network attached storage (NAS) system.

In some embodiments, processor 400 is operatively coupled to storage device 420 via a storage interface 410. Storage interface 410 may be comprised of any component capable of providing processor 400 with access to storage device 420. Storage interface 410 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 400 with access to storage device 420.

Memory areas 360 (FIG. 3) and 430 (FIG. 4) may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Out of home electronic, digital media devices (e.g., digital billboards, digital signs, etc.) are becoming prevalent throughout the world wherever people gather for any event. These devices offer an opportunity to market products through full motion and/or static advertising. The present disclosure provides methods and systems operable to connect buyer end users (e.g., suppliers of goods and/or services, buyers of advertising space, etc.) with a desired media device having advertising space available.

As shown in the example of FIG. 5, auction systems, such as auction and management system 60, are utilized by various parties to offer, conduct, and conclude auctions of advertising space on electronic, digital media. A broker 440 is the broker and administrator of system 60. Broker 440 is responsible for processing of advertising space and its eventual purchase. Digital media device owners 450, also referred to as owner/operator 450, manage their asset inventory (e.g., the digital media devices owned and/or operated), their advertising time slots available on those assets, and the formulation of the eventual listings to be offered for sale using auction system 60. A buyer end user and/or professional user 470, sometimes referred to as buyer 470, is the purchaser of advertising space listed for sale on system 60.

System 60 presents a web application and/or user interface to buyer 470. Buyer 470 navigates to the web application via any Internet connected computing device, such as a personal computer, a laptop or tablet, a personal assistance device, or a mobile phone. Once buyer 470 navigates to the web application, buyer 470 can register for an account with system 60 and log onto the auction web application after registration. Registered and logged-in buyers 470 may navigate through the auction web application, search posted media time slot listings, evaluate listing details for applicability with their desired target audience and location for advertising, bid on listings, purchase (without auction) listed advertising via a buy now operation, and purchase listings won at auction or through a buy now. Registered and logged-in buyers 470 serving as capacity of a professional user may navigate through a buy planner application, create buy plans outlining search criteria, perform a search using the buy plan criteria, evaluate the listing details for applicability with their desired target audience and location for advertising, purchase the listed via purchase action.

System 60 also presents a web application and/or user interface to digital media device owners 450. Owners 450 navigate to the web application via any Internet connected computing device, such as a personal computer, a laptop or tablet, a personal assistance device, or a mobile phone. Once an owner 450 navigates to the web application, owner 450 can register for an account with system 60 and log onto the auction web application after registration. Registered and logged-in owners 450 may create and manage asset inventories and profiles (including, for example, geographic location, size of asset, display characteristics, etc.), create and manage available time slots for assets in the owner's inventory, create listings of advertising time slots for sale via auction and/or buy now, and conclude sales made through system 60.

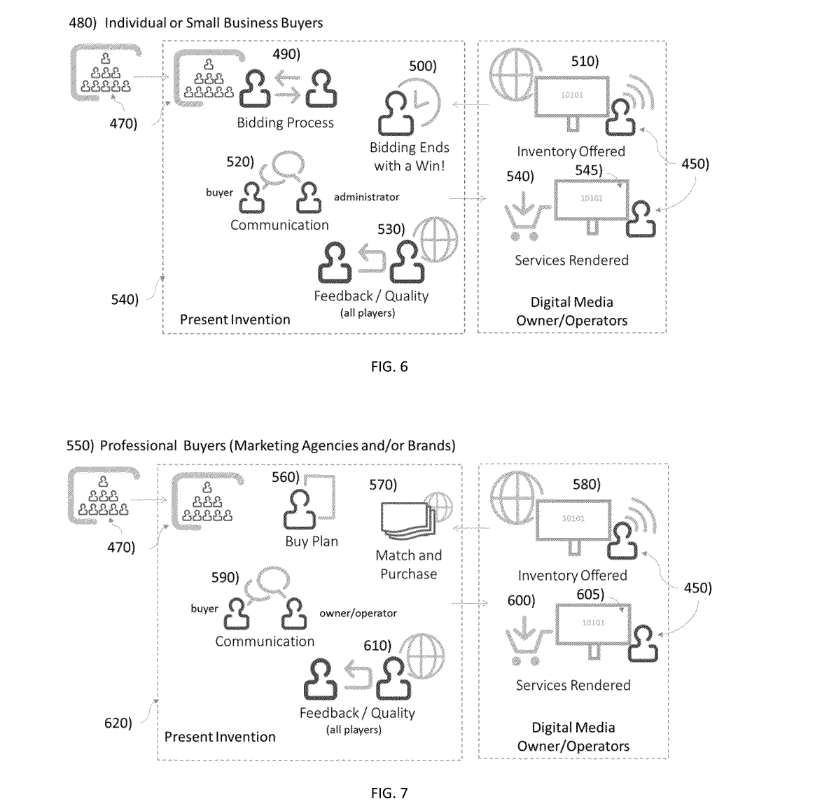

FIG. 6 presents an example of a typical auction process 480 using the auction web application of system 60 described above. Other examples are also possible. The owner/operator 450 of an electronic digital media device 510 offers up advertising time slots to system 60. System 60 posts and/or makes public the listing. Buyer end user 470 begins the bidding process 490 by submitting a bid on a particular listing of his choice. The auction process continues until an end time of the listing, which was selected by the owner 450 who created the listing. Multiple buyer end users 470 may bid on the same listing. At 500, the winner is the buyer 470 who submitted the highest bid. Communication 520 with the buyer end user 470 is commenced via a messaging and invoicing system portion of system 60. In some examples, system 60 automatically messages and invoices buyer 470. In other examples, broker/administrator 440 (FIG. 5) initiates messaging and invoicing. The wining buyer end user 470 uploads advertising messaging and artwork to system 60. The uploaded materials are forwarded by system 60 to owner/operator 450. The services are rendered 540 by posting, by the owner 450, the buyer's uploaded advertising on the electronic digital media device 545 according to the terms of the concluded listing. A feedback/quality control mechanism 530 is available to the buyer end user 470 to provide feedback for overall experience of the purchase process. This feedback is also made available to owner/operator 450.

FIG. 7 presents an example buy plan and purchase process 550 using the auction web application of system 60. The owner/operator 450 of an electronic digital media device 580 offers up advertising time slots to system 60. System 60 posts and/or makes public the listing. Buyer end user 470 (as a professional user) begins by creating a buy plan 560 to include search criteria made up of regions, categories, postal codes with radius, demographics, and a dollar amount budget, for example. Buyer end user 470 (as a professional user) submits this buy plan to system 60 for evaluation against available listings provided by owner/operator 450. System 60 will perform the match 570 and present the results to the buyer end user 470 (as a professional user) for evaluation. Once buyer end user 470 (as a professional user) is satisfied, they may make a final purchase of all listings that match the buy plan criteria. Communication 590 with the buyer end user 470 is commenced via a messaging and invoicing system portion of system 60. In some examples, system 60 automatically messages and invoices buyer 470. In other examples, broker/administrator 440 initiates messaging and invoicing. The wining buyer end user 470 uploads advertising messaging and artwork to system 60. The uploaded materials are forwarded by system 60 to owner/operator 450. The services are rendered 600 by posting, by the owner 450, the buyer's uploaded advertising on the electronic digital media device 605 according to the terms of the concluded listing. A feedback/quality control mechanism 610 is available to the buyer end user 470 to provide feedback for overall experience of the purchase process. This feedback is also made available to owner/operator 450.

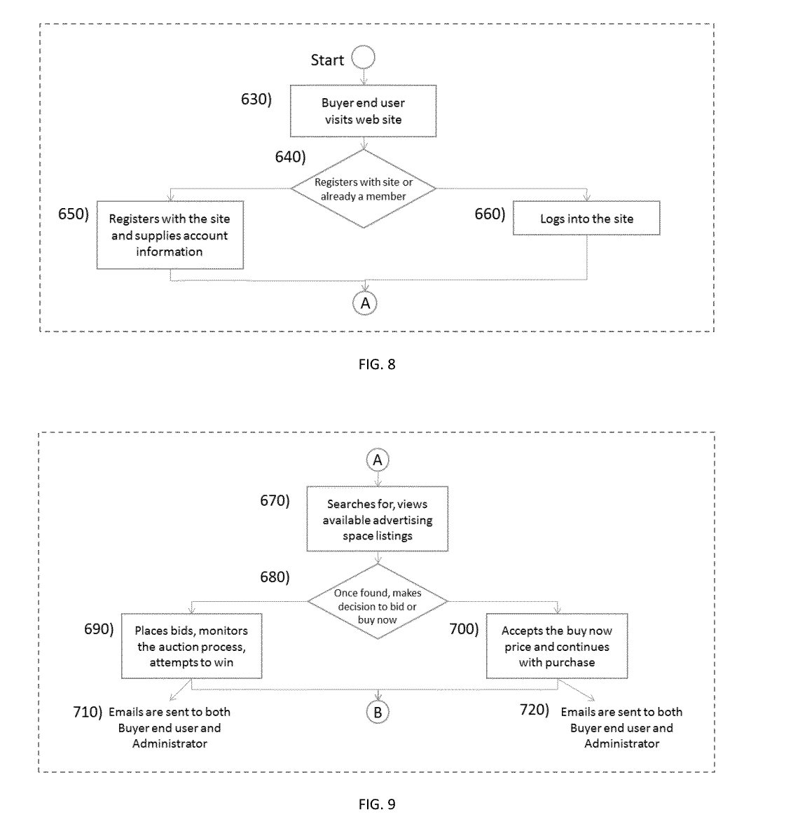

The auction and purchase process will be further explained with reference to the examples illustrated in FIGS. 8-12. Turning first to FIGS. 8 and 9, buyer end user 470 visits (step 630) the web application site of system 60. At step 640, buyer 470 either registers (step 650) with the application or logs onto the application (step 660). Once logged into the application, the buyer end user 470 may search for and view available advertising space listings (step 670). When a desired advertising space listing is found, buyer 470 makes a decision (step 680) to either bid on or purchase (via a buy now) the listing. If buyer 470 chooses to bid (step 690), buyer 470 will place a bid amount and monitor and participate in the auction process until there is a winner. If buyer 470 chooses to purchase (step 700) the listing at the specified purchase amount, buyer 470 will commence with the buy now process. In either case, emails are sent out (steps 710 and 720) to the buyer end user 470 and the broker/administrator 440 to notify and document activity associated with that listing.

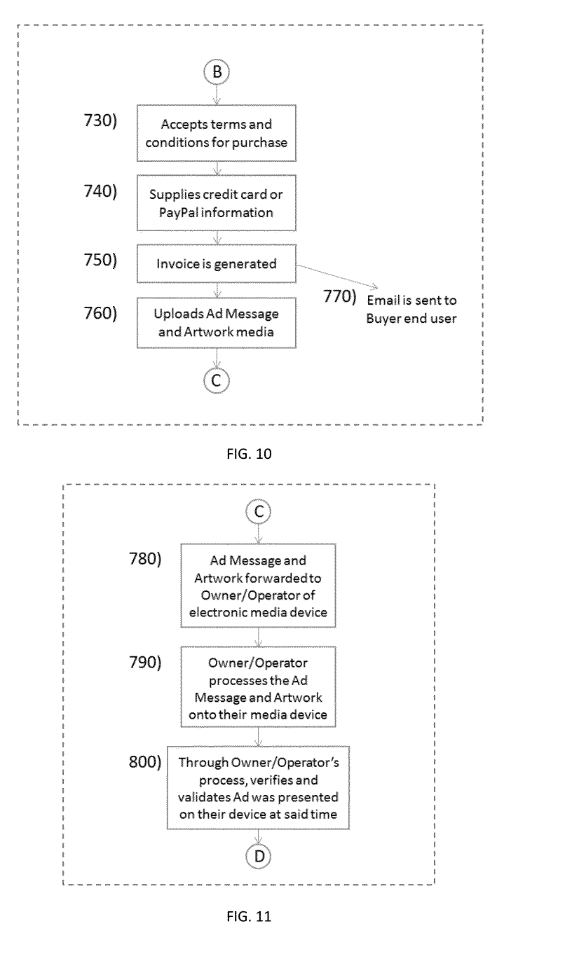

Referring to FIG. 10, once a buyer end user 470 either wins the auction or performs a buy now, buyer 470 accepts (step 730) the terms and conditions of the purchase, supplies payment (step 740) (via credit card or other payment service). An invoice is generated (step 750), which is sent (step 770) via email to buyer end user 470. Buyer end user 470 then proceeds to upload (step 760) the desired advertising message and artwork to system 60.

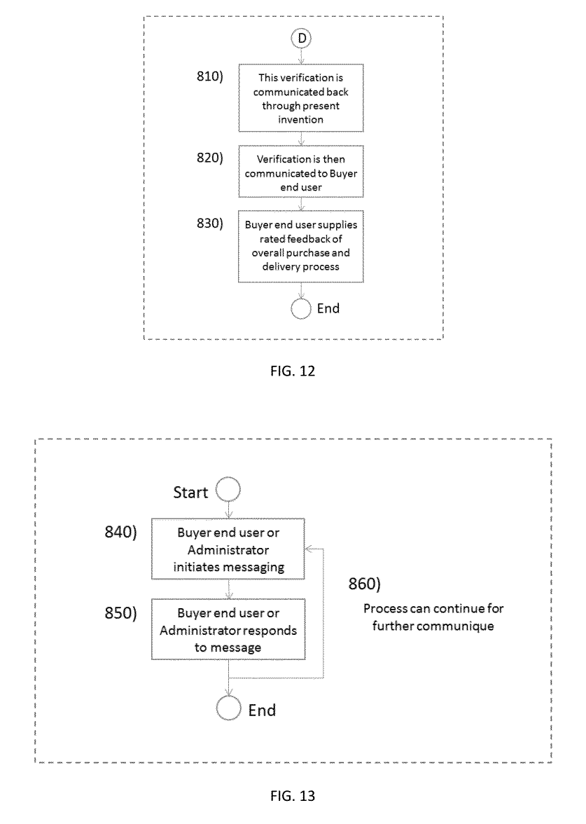

In FIGS. 11 and 12, the advertising message and artwork materials are the forwarded (step 780) to the owner/operator 450 of the electronic digital media device. The owner/operator processes (step 790) the advertising message and artwork onto the electronic digital media device after a review of the materials according to the owner's policies and/or any applicable regulatory restrictions. The owner/operator 450 verifies and validates (step 800) that the advertising took place on the electronic digital media device. This verification is available for buyer end user 470 and can be uploaded (step 810) to system 60 for communication (step 820) to buyer end user 470. At any time throughout the process, buyer end user 470 can supply rated feedback of the overall purchase and delivery process through a quality control mechanism of the system (step 830).

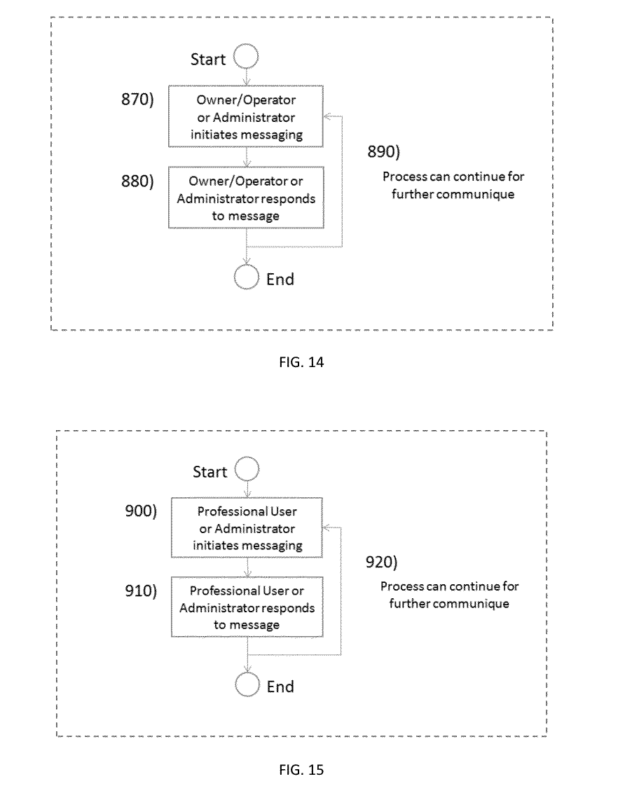

With reference to FIGS. 13 and 14, at any time, buyer end user 470 and owner 450 can communicate with the administrator 440 of system 60 with questions, comments, or concerns related to any aspect of the present disclosure and its processes. As shown in FIG. 13, communication between buyer 470 and broker/administrator 440 is initiated (step 840) through a messaging mechanism and the administrator 440 or buyer 470 will respond (step 850) sometime later. This process can repeat as necessary (step 860) Likewise, as shown in FIG. 14, communication between owner 450 and broker 440 is initiated (step 870) through a messaging mechanism and the other party may respond (step 880) sometime later. This process can repeat as necessary (step 890).

FIG. 15 presents a similar functionality for professional buyer end users. At any time, the professional buyer end user 470 and owner 450 can communicate with the administrator 440 of system 60 with questions, comments, or concerns related to any aspect of the present disclosure and its processes. As shown in FIG. 15, communication between buyer 470 and broker/administrator 440 is initiated (step 900) through a messaging mechanism and the administrator 440 or buyer 470 will respond (step 910) sometime later. This process can repeat as necessary (step 920).

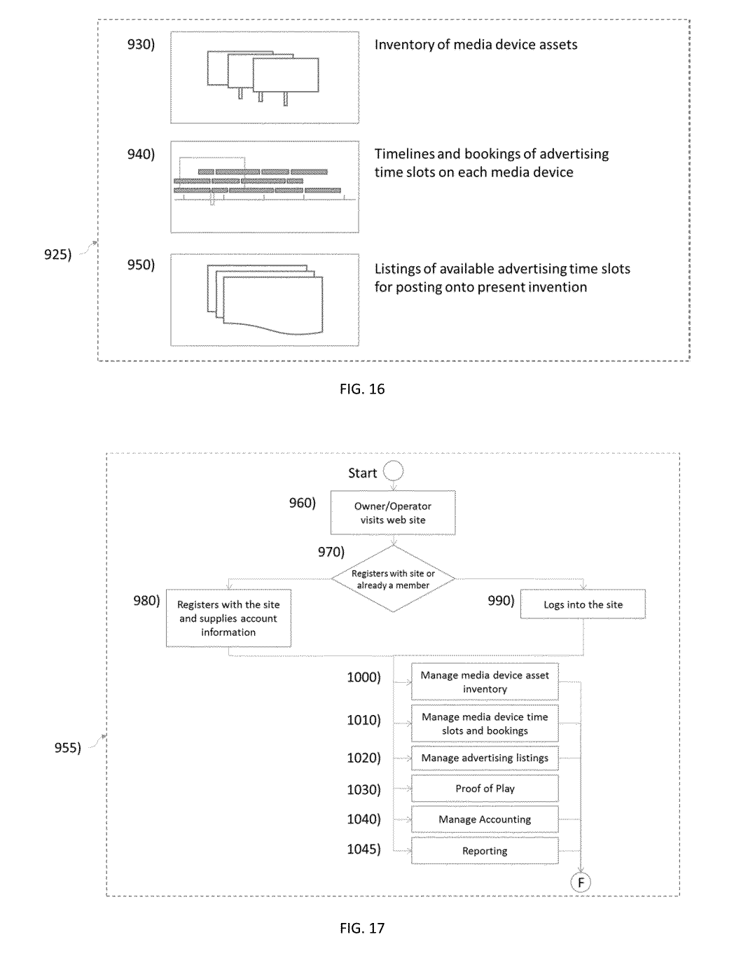

FIG. 16 shows the management system component 925 of system 60, which will be described with reference to the flow diagrams of FIGS. 17-23. FIG. 16 is a functional block diagram of management system 925. Management system 925 is available to owner/operators 450 through system 60. Management system 925 provides owner/operators 450 with an inventory management portion 930 to manage their digital media device inventory, a timeline portion 940 to manage each media device's timelines and capture all time slots representing advertising space, and an advertising listing portion 950 to manage their advertising listings posted with system 60.

FIG. 17 is a flow diagram 955 of the owner/operator's experience with management system 925. The owner/operator 450 visits the system's web application at step 960. At step 970, if owner 450 is not already registered, owner 450 chooses to register (step 980) with the web application, supplies their account information, and establishes a profile. If owner 450 is registered, owner 450 chooses to log in (step 990) to the web application and begin using the available management system 925 tools.

Management system 925 includes several tools, such as: an electronic digital media device inventory 1000, a timeslot toolset 1010 for managing time slots and bookings on the inventory of devices, a listing toolset 1020 for managing advertising space listings, a proof of play toolset 1030, an accounting management toolset 1040, and a reporting toolset 1045 allowing for general and enterprise level reporting.

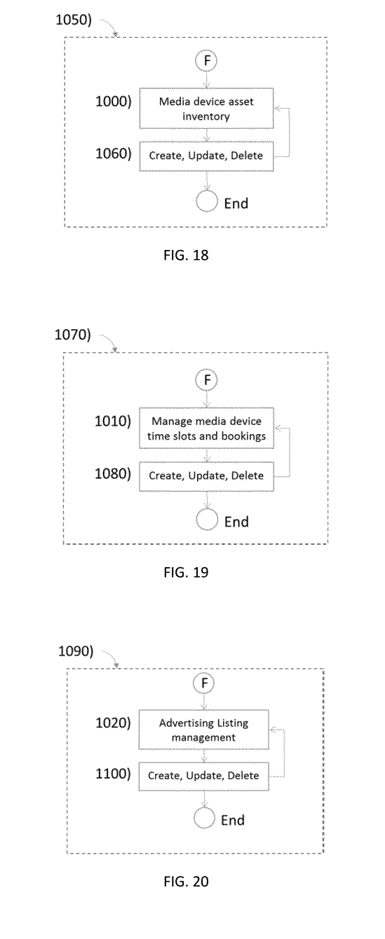

FIG. 18 is a flow diagram 1050 of device inventory 1000. Device inventory (step 1000) functions to assist the owner/operator 450 to manage their electronic digital media assets. Owner/operator 450 has the ability to create, update, and delete (step 1060) any of their electronic digital media assets. The assets are presented to owner 450 in a list format. Each asset has a timeline and bookings schedule associated with it to illustrate the time slots of advertising space on that particular asset.

FIG. 19 is a flow diagram 1070 of timeslot toolset 1010. Timeslot toolset 1010 allows owner/operator 450 to manage their advertising time slots and/or bookings on each electronic digital media asset in device inventory 1000. The owner/operator can create, update, and delete (step 1080) any of their advertising time slots and/or booking on any electronic digital media asset.

FIG. 20 is a flow diagram 1090 of listing toolset 1020. Listing toolset 1020 allows owner/operator 450 to manage their advertising listings posted with (or to be posted onto) the system 60. Owner/operator has the ability to create, update, and delete (step 1100) any of their advertising listings. Each listing is associated with at least one of the owner/operator's electronic digital media assets and at least one time slot allocated on the device. Creating a listing reserves the particular time slot(s) on a specific media device. Each listing will contain specifications of the digital media hardware, digital file requirements for artwork to be submitted, pictures of the sign and/or surrounding area, a sales marketing brochure can be associated with the listing, and one or more demographics can be specified. The listing can be pushed to the auction site for public viewing and purchase by buyer end user (as well as, professional user) 470. Once that advertising listing is purchased through the system, the buyer end user's advertising message and artwork will be loaded onto the electronic digital media asset by the owner/operator 450 for presentation to the public.

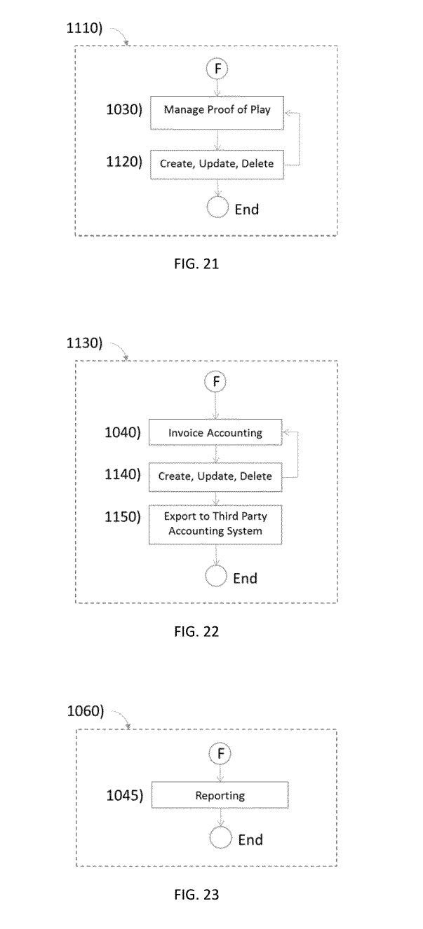

FIG. 21 is a flow diagram 1110 of the proof of play toolset 1030. Proof of play is a file that contains proof that the advertisement was played on the digital media device and can be made up of timestamp entries marked by the digital media device at the time of play. It can also include a picture of the advertisement on the digital media device itself. The owner/operator 450 can create, update, and delete (step 1120) this proof of play file with the listing which is uploaded and sent to the buyer end user 470 for their evaluation.

FIG. 22 is a flow diagram 1130 of accounting management toolset 1040. Management toolset 1040 allows owner/operator 450 to manage accounting associated with system 60. In particular, accounting management toolset 1040 permits owner/operator 450 to create, update, and delete (step 1140) invoices. Invoices and accounting data can be exported (step 1150) from accounting management toolset 1040 to third party accounting systems and software.

FIG. 23 is a flow diagram 1060 of the reporting toolset 1045. The reporting toolset 1045 allows the owner/operator 450 to evaluate executive and/or dashboard data in a report format of all of their inventory, listings, accounting, etc.

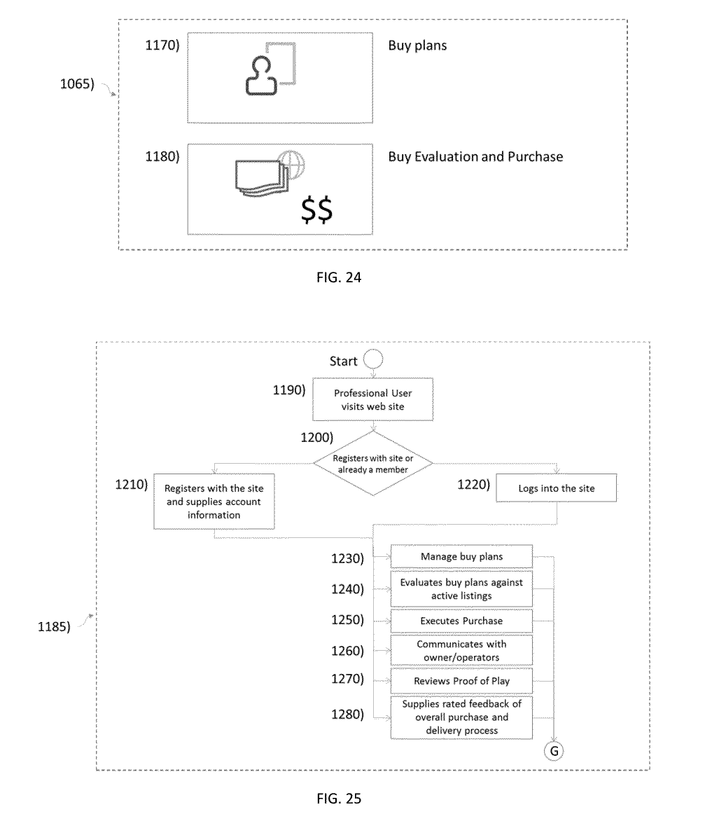

FIG. 24 shows the buy planner system component 1065 of system 60, which will be described with reference to the flow diagrams of FIGS. 25-31. FIG. 24 is a functional block diagram of buy planner system 1065. The buy planner system 1065 is available to professional buyer users 470 through system 60. The buy planner system 1065 provides professional buyer users 470 with buy plan portion 1170 to manage their buy plans and a buy evaluation and purchase portion 1180 to manage their purchases based upon their buy plan 1170.

FIG. 25 is a flow diagram 1185 of the professional buyer end user's experience with buy planner system 1065. The professional buyer end user 470 visits (step 1190) the system's web application. At step 1200, if professional buyer end user 470 is not already registered, professional buyer end user 470 chooses to register (step 1210) with the web application, supplies their account information, and establishes a profile. If professional buyer end user 470 is registered, professional buyer end user 470 chooses to log in (step 1220) to the web application and begin using the available buy planner system 1065 tools.

Referencing FIG. 25, the buy planner system 1065 includes several tools: a buy plan manager 1230, a buy plan evaluation toolset 1240 for evaluating active listings against the buy plan established in 1230, a toolset to purchase 1250 active listings based upon the buy plan established in 1230, a communications toolset 1260 to communicate with the owner/operator 450, a proof of play review toolset 1270 to review the results of the advertising played on the electronic media devices, and a rating feedback toolset 1280 to provide the owner/operator 450 and the system 60 with overall purchase and delivery process.

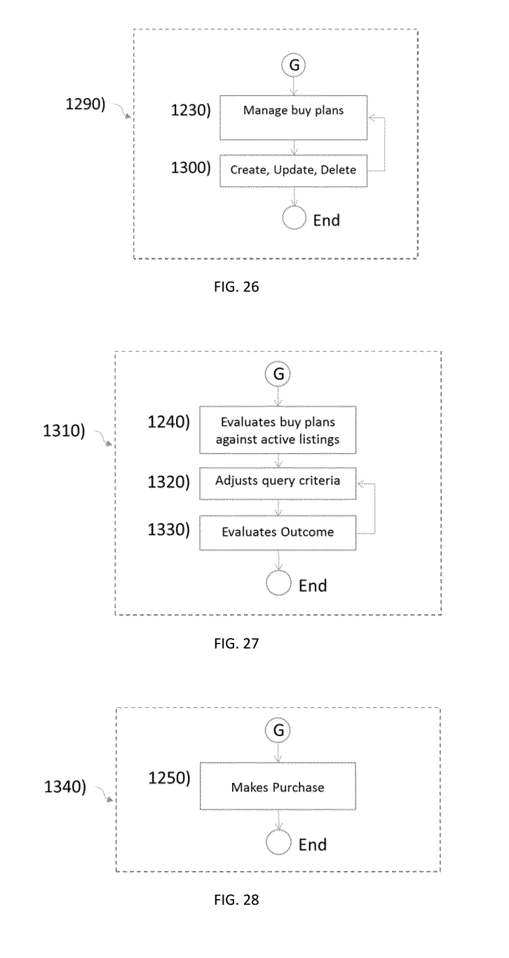

FIG. 26 is a flow diagram 1290 of buy plan manager 1230. Buy plan manager 1230 functions to assist the professional buyer end user 470 to manage their buy plans. Professional buyer end user 470 has the ability to create, update, and delete (step 1300) any of their buy plans. The buy plans are presented to professional buyer end user 470 in a list format. Each buy plan has details regarding the plan, including a name, description, date range, personnel involved, target audience, demographics, postal codes, regions, categories, etc.

FIG. 27 is a flow diagram 1310 of the buy plan evaluator 1240. The buy plan evaluator 1240 functions to take the buy plan criteria and evaluates it against active listings in system 60. Those listings that match the criteria, are presented to the professional buyer end user 470 in a visual manner, as well as, in a listing. From there the professional buyer end user 470 can make adjustments to the buy plan criteria (step 1320) to narrow down their search and evaluate the outcome (step 1330) of their adjustments in step 1320. This process may be repeated until the professional buyer end user 470 is satisfied.

FIG. 28 is a flow diagram 1340 of the purchase toolset 1250. The purchase toolset 1250 functions as the last step in the buy planner system 1065 process, whereby the professional buyer end user 470 purchases those listings matching the criteria set forth in their buy plan.

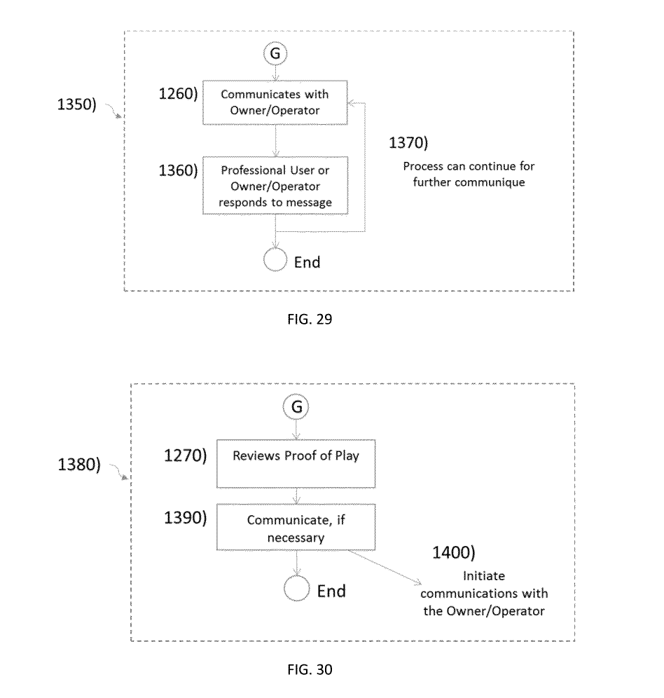

FIG. 29 is a flow diagram 1350 of the communications toolset 1260. The communications toolset 1260 functions as a means for the professional buyer end user 470 to communicate with the owner/operators 450 of the active listings that the professional buyer end user 470 has purchased via step 1250. The communications (step 1360) that occur using the communications toolset 1260 between the professional buyer end user 470 and the owner/operators 450 deals with specifics as to how the advertising will be formatted, delivered, and presented on their digital media devices associated with the active listings that were purchased. This process can repeat as necessary (step 1370).

FIG. 30 is a flow diagram 1380 of the proof of play toolset 1270. The proof of play toolset 1270 functions as a means for transmitting the proof of play of the advertisement played on the digital media devices. The owner/operators 470 will send their normal proof of play files to the professional buyer end user 470 via the proof of play toolset 1270. The professional buyer end user 470 may evaluate the proof of play outcomes and communicate (step 1390), if necessary, with the owner/operators. At step 1400, communications are initiated with the owner/operator. This process may repeat, if necessary.

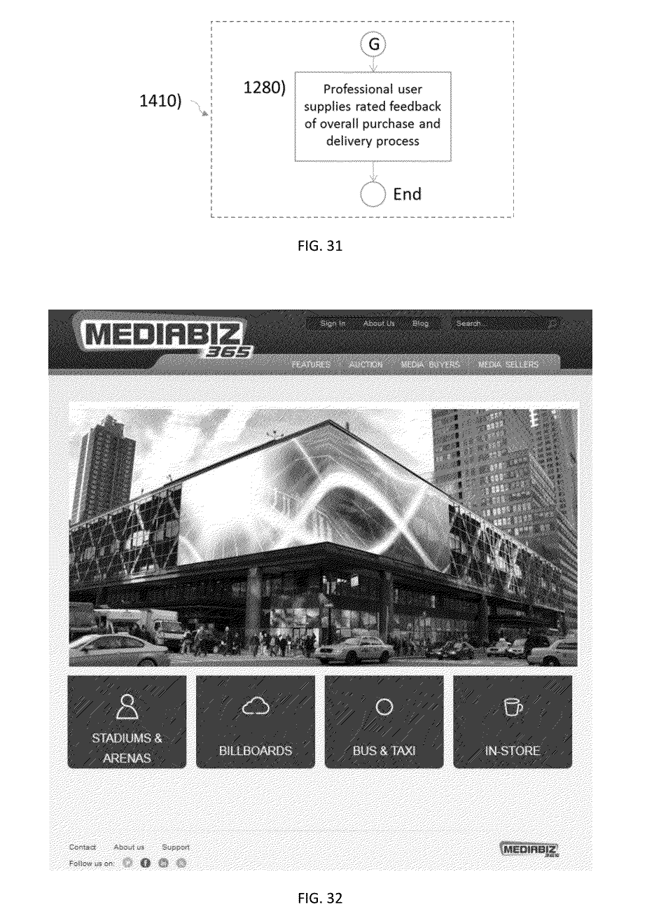

FIG. 31 presents a flow diagram 1410 of the feedback toolset 1280. The feedback toolset 1280 functions as a means for supplying feedback to the owner/operator 450 and the system administrator 440 regarding the overall purchase and delivery of the professional buyer end user's 470 advertisement on various digital media devices associated with the listings they've purchased through the buy planner system 1065.

FIG. 32 is screen capture of an example of a web application for online auctions of digital, electronic media advertising according to the present disclosure. Other embodiments may include a different web applications, different pages, different layouts, and/or different features. More specifically, FIG. 32 is a screen capture of a home page presented to a user (broker/administrator 440, owner/operator 450, and/or buyer end user 470 (including the professional user) when the user navigates to the web application provided by, for example, system 60.

In the preceding detailed description, the invention is described with reference to specific exemplary embodiments thereof. Various modifications and changes may be made thereto without departing from the broader spirit and scope of the invention as set forth in the claims. The specification and drawings are, accordingly, to be regarded in an illustrative rather than a restrictive sense.

1: A computing device for facilitating sales of advertising space on out of home digital billboards and signs, the computing device comprising a processor and a memory coupled to said processor, wherein said memory comprises computer-executable instructions that, when executed by said processor, cause said computing device to:
generate, based on advertising space data provided by an out of home digital billboard or sign owner, an electronic listing of an advertising space available for purchase for display on the out of home digital billboard or sign;
receive from at least one prospective buyer, at least one bid for purchase of the advertising space;
end the electronic listing of the advertising space at a predetermined time after the electronic listing was generated;
determine a winning bidder for the listing of the advertising space, wherein the winning bidder is the prospective buyer who submitted the highest bid for purchase of the advertising space;
notify the winning bidder of the submission of the highest bid for purchase of the advertising space upon expiration of the predetermined time;
receive payment transaction information from the winning bidder after the notification;
receive advertising materials from the winning bidder;
provide the advertising materials to the out of home digital billboard or sign owner; and then transform the digital billboard or sign to display a visual image using the advertising materials from the winning bidder.

2-3. (canceled)

4: The computing device of claim 1, wherein the advertising space comprises at least a portion of a particular digital billboard or sign and a time slot.

5: (canceled)

6: The computing device of claim 1, wherein said memory further comprises computer-executable instructions that, when executed by said processor, cause said computing device to:
receive, from the digital billboard or sign owner, advertising space data including identification of at least one digital billboard or sign and at least one time slot during which advertising is available for sale.

7: (canceled)

8: The computing device of claim 1, wherein said memory further comprises computer-executable instructions that, when executed by said processor, cause said computing device to:
allow the prospective buyer to configure a buy plan, wherein the buy plan matches advertising space based on buy plan criteria.

9: The computing device of claim 8, wherein the buy plan criteria includes one or more of desired geographic regions, desired demographics, and a budget.

10: The computing device of claim 8, wherein said memory further comprises computer-executable instructions that, when executed by said processor, cause said computing device to:
evaluate the buy plan criteria against active electronic listings of advertising space available.

11-15. (canceled)

16: A method for facilitating sales of advertising space on out of homes digital billboards and signs, comprising:
generating a plurality of electronic listings using a first computing device of out of home digital billboards or signs with advertising space available for purchase based on advertising space data provided by out of home digital billboard or sign owners;
receiving bids on a server associated with the first computing device from one or more additional computing devices of prospective buyers for purchase of one or more of the electronic listings of advertising space available for purchase;
ending the respective electronic listings of the advertising space at a predetermined time after the respective electronic listing was generated;
determining with the server a winning bidder for the respective electronic listing of the advertising space, wherein the winning bidder is the prospective buyer who submitted the highest bid for purchase of the respective advertising space;
notifying the winning bidder of the submission of the highest bid for purchase of the advertising space upon expiration of the predetermined time;
receiving payment transaction information from the winning bidder after the notification;
receiving advertising materials from the winning bidder;
providing the advertising materials to the digital billboard or sign owner; and then transforming the digital billboard or sign to display a visual image using the advertising materials from the winning bidder.

17: (canceled)

18: The method of claim 17, further comprising allowing the prospective buyer to configure a buy plan, wherein the buy plan matches advertising space based on buy plan criteria.

19: The method of claim 18, wherein the buy plan criteria includes one or more of desired geographic regions, desired demographics, and a budget.

20: The method of claim 18, further comprising evaluating the buy plan criteria against active electronic listings of advertising space available.

21: The computing device of claim 1 wherein the electronic listing includes a buy now price.

22: The computer device of claim 21 wherein said memory further comprises computer-executable instructions that, when executed by said processor, cause said computing device to end the electronic listing of the advertising space upon receipt of an acceptance of the buy now price from a buyer.

23: The method of claim 16 further comprising providing a buy now price for one or more of the electronic listings of advertising space.

24: The method of claim 23 further comprising ending the electronic listing of advertising space upon receipt of an acceptance of the buy now price from a buyer.
